(19) United States
(12) Patent Application Publication
(10) Pub. No.: US 2003/0069725 A1
(43) Pub. Date: Apr. 10, 2003

(54) Deterministic method of experimental design

(76) Inventor: Brian K. Southern, Ellicott City, MD (US)

Correspondence Address: John R. Posthumus, Esq., LeBoeuf, Lamb, Greene & MacRae, L.L.P., 633 Seventeenth Street, Suite 2000, Denver, CO, 80202, US

(21) Appl. No.: 10/268,272

(22) Filed: Oct. 9, 2002

Related U.S. Application Data
(60) Provisional application No. 60/328,325, filed on Oct. 9, 2001.

(51) Int. Cl. G06F 9/45

(52) U.S. Cl. 703/22

(57) ABSTRACT

A system and method for designing experiments, preferably in the research and development arena, is disclosed. The system and method of experimental design reduces the time-to-market and costs associated with discovery, pre-development and development of new chemical, pharmaceutical, biological and biotechnological compounds.

### RELATED APPLICATION

This patent application claims priority to U.S. Provisional Application Serial No. 60/328,325, filed Oct. 9, 2001, which is incorporated herein by reference.

### FIELD OF THE INVENTION

This invention relates generally to the field of experimental design. In particular, this invention relates to a deterministic system and method for designing experiments for research and development.

### BACKGROUND OF THE INVENTION

Classical approaches to designing newer chemical experiments, to cover a spectrum of possibilities, involve varying all possible variables related to a parent experiment. Such an approach yields an array of experiments, which, when performed, produce responses that vary over a wide range.

Determining the optimum experiment or direction of future experiments, based on these responses, depends in part on the ability to manage extremely vast quantities of data, the ability to perform such an array of experiments, and the quality of the responses. Due to complexities involved in conventional experimental design approaches, and in an attempt to improve upon the data generated, researchers have applied various techniques borrowed from other areas of science and technology. One such technique involves the use of statistical experiment design to determine the cause and effect relationship.

By way of background, statistical experimental design generally refers to the determination of relationships between experimental variables and its corresponding responses. It was first developed in the agricultural industry and thereafter became a tool for quality improvement. The application of conventional experimental design method was maximized in the process or manufacturing industry where its use was primarily seen in the manipulation of multiple process variables, such as temperature, pressure, time, etc.

Recent improvements in the use of this technique have been stimulated by the rapid growth in the electronics and automobile industry where statistical experiment design's efficient use was noticed. Also, the increase in computational power of personal computers added to the capability of handling complex multivariate calculations.

With the advent of High Throughput Screening (HTS) and High Throughput Experimentation (HTE) for drug discovery and development, a desperate need arose to design effective experiments to increase efficiency in experimentation techniques. Despite its extensive use in HTS and HTE, conventional experimental design methods have not produced substantive improvements in the drug discovery process. The result has been more data, but not necessarily improved data.

One problem with conventional statistical experimental designs, particularly as to its application to designing new chemical experiments, is the unavailability of accurate response information for unknown experiments.

Another problem with conventional statistical experimental designs, is the unavailability of accurate response information for newly designed experiments.

Yet another problem with conventional statistical experimental designs, is the high degree of computational complexity involved in dealing with a large number of experiments designed by statistical methods. While statistical methods, compared to classical methods, reduce the number of experiments to be performed, the computational complexity is not significantly reduced, since computations are still too large for efficient management of experiments and data.

What is more, the limitations of laboratory equipment in performing the very large numbers of experiments generated by the design, thwarts the possible use of statistical experimental design as a sole tool for efficient determination of direction of future experiments.

For these and other reasons, a need therefore exists for an improved system and method of experimental design.

### SUMMARY OF THE INVENTION

The present invention satisfies, to a great extent, the foregoing and other needs not currently satisfied by existing experimental design systems. One feature and advantage of the present invention is to provide a system and method of experimental design that provides improved data in less time.

It is another feature and advantage of the present invention to provide a system and method of experimental design method that generates analysis of data in real time.

It is another feature and advantage of the present invention to provide a system and method of experimental design method that facilitates updated experimental design, resulting in on-the-fly experiment amendment or truncation.

It is another feature and advantage of the present invention to provide a system and method of experimental design method that reduces reagent costs and/or costs of byproduct disposal.

It is another feature and advantage of the present invention to provide a system and method of experimental design method that substantially minimizes the unnecessary generation of hazardous waste.

It is another feature and advantage of the present invention to provide a system and method of experimental design method that minimizes the amount of physical experimentation required for a study.

It is another feature and advantage of the present invention to provide a system and method of experimental design method that reduces the time-to-market for new chemical, pharmaceutical, biological, and/or biotechnological compounds.

It is another feature and advantage of the present invention to provide a system and method of experimental design method that reduces the costs associated with discovery of new chemical, pharmaceutical, biological, and/or biotechnological compounds.

It is another feature and advantage of the present invention to provide a system and method of experimental design method that reduces the costs associated with pre-development of new chemical, pharmaceutical, biological, and/or biotechnological compounds.

It is another feature and advantage of the present invention to provide a system and method of experimental design method that reduces the costs associated with development of new chemical, pharmaceutical, biological, and/or biotechnological compounds.

It is another feature and advantage of the present invention to provide a system and method of experimental design method that is less expensive than conventional techniques.

It is another feature and advantage of the present invention to provide a system and method of experimental design method that is adaptable and configurable to existing laboratories.

It is another feature and advantage of the present invention to provide a system and method of experimental design method that is manageable in its implementation.

It is another feature and advantage of the present invention to provide a system and method of experimental design method that is user transparent and employs existing commands of a PC applications program.

The above features and advantages are accomplished by a deterministic system and method for designing experiments for research and development. In accordance with one embodiment, a system for designing experiments is disclosed. The system comprises a communications system, an experiment evaluation and refinement system, a modeling system, a formulations system, a recipe management system, and a visualization system.

In another aspect of the present invention, a deterministic method for designing experiments is disclosed. The method comprises the steps of: determining revised experimentation boundaries, estimating a profile of a chemical entity, performing a comparison analysis of the profile with previously input experimentally determined chemical values, and determining whether the comparison of calculated values and experimentally determined values converge to a satisfactory minima.

There has been thus outlined, rather broadly, the important features of the invention in order that a detailed description thereof that follows may be better understood, and in order that the present contribution may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or drawing illustrations. The present invention is capable of other embodiments and of being practiced and carried out in various ways.

Additionally, it is to be understood that the terminology and phraseology employed herein are for the purpose of description and should not be regarded as limiting.

As such, those skilled in the art will appreciate that the conception, upon which this disclosure is based, may readily be used as a basis for designing other structures or infrastructures, methods and systems for carrying out the several features and advantages of the present invention. It is important, therefore, that the claims be regarded as including such equivalent constructions insofar as they do not depart from the spirit and scope of the present invention.

### BRIEF DESCRIPTION OF PREFERRED EMBODIMENTS

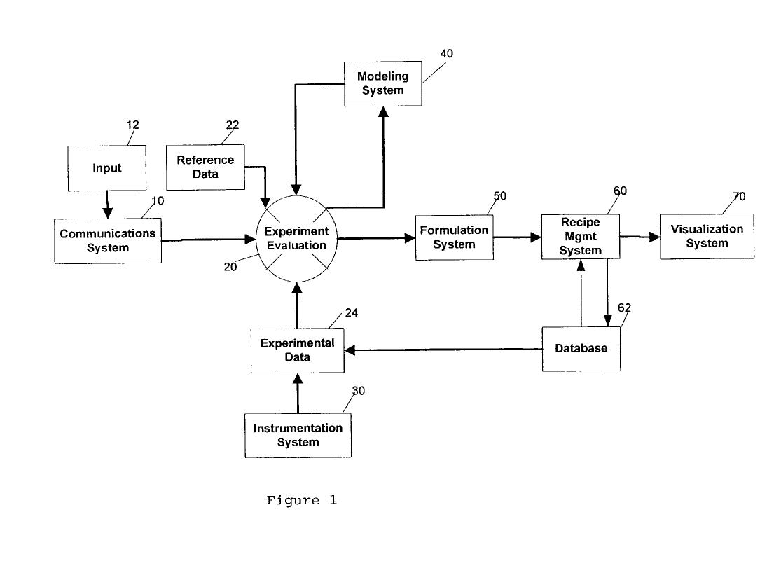

FIG. 1 illustrates a schematic diagram of components of the overall architecture of the present invention according to one embodiment.

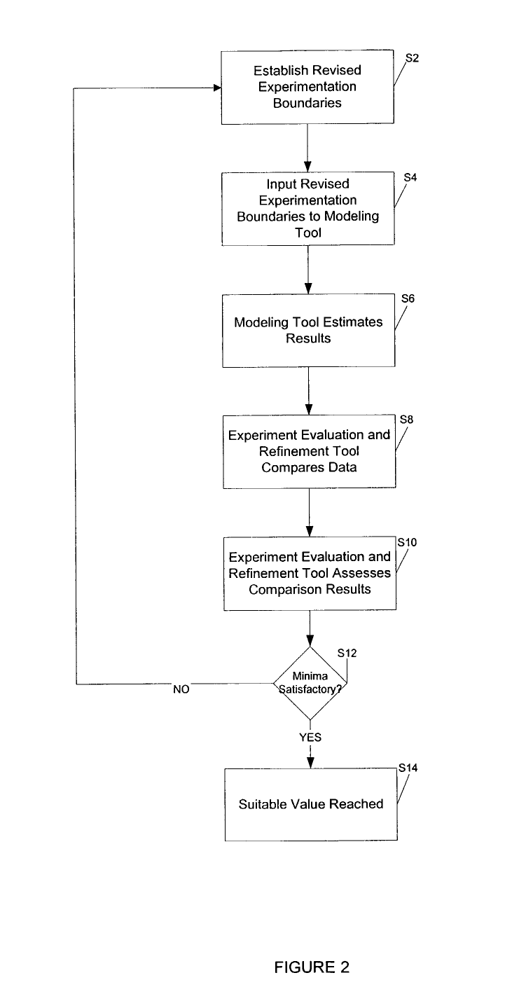

FIG. 2 is a flow chart illustrating operation of the experimental design system of the present invention, in accordance with a preferred embodiment.

### DETAILED DESCRIPTION OF PREFERRED EMBODIMENTS

Referring now to FIG. 1, a diagram showing the overall architecture of the present invention is illustrated, in accordance with one embodiment. The components of the system and method of experimental design of the present invention, includes interaction between a communications system 10, an experiment evaluation and refinement system 20, an instrumentation system 30, a modeling system 40, a formulation system 50, a recipe management system 60, and a visualization system 70.

In a preferred embodiment, the present invention contemplates the use of the present invention in a laboratory environment where chemical experiments, for instance, are performed. In this scenario, initial experimental boundaries are determined by one or more factors, such as a targeted research area, or a targeted new chemical or biological entity or compound.

Information establishing these experimental boundaries is provided through inputs 12 to the communications module or system 10 for processing. Input 12 provides broad parameters relating to the focus question and/or hypothesis at issue, as well as environment restraints.

The type of input 12 may be generally classified as manual input or imported input. Manual input may be described as user-entered input and/or user-defined input, such as user-specified restraints. These restraints, in turn, may be classified as guidelines or as requirements. Guidelines are substantially weighted as suggestions, whereas requirements are substantially weighted as absolutes.

Imported input, on the other hand, may be referred to as data transferred electronically from a database (online or otherwise) or discovery tool. Discovery tools may include, but are not limited to, structure simulators, primary screening workstations, secondary screening workstations, results of electronic search tools, analytical instruments, or the like. Online databases may include, but are not limited to, data repositories, such as sequence repositories, journal articles, and the like.

The nature and type of input 12 comprises information substantially relating to theoretical and environmental constraints, which may include, but is not limited to, process variables, operating conditions, molecular structure, quantum mechanics, financial constraints, equipment limitations, safety guidelines, available resources, preliminary data, first principle properties, etc. Input 12 may also relate to chemical, biological, physical, mathematical, or other properties. In other words, the communications system 10 is configured for accepting and processing information relating to theoretical possibilities available in light of known constraints; that is, initial experimental boundaries.

For example, in one embodiment of the present invention, data input 12 may comprise results of complex chemical reactions, such as polymerization, which may involve upwards of twenty-five reagents. In accordance with one measure, input 12 is classifiable as having varying degrees of importance. A data's degree of importance depends on one or more parameters, which may be user defined. In one instance, a scientist interested in attributing a high degree of importance on a chemical entity's specific prediction concentration, may select output data that shows the degree to which calculated values of the entity's concentration correlate with experimental values.

The communications system 10 produces the data input 12 in a desired format to an experiment evaluation and refinement system 20. The primary function of the experiment evaluation and refinement system 20 is to assess the initial experimental boundaries in view of reference data 22 and experimental data 24 supplied to it. Preferably, one or more internal and/or external databases are mined for reference data 22 and experimental data 24.

Generally, reference data 22 comprises information related and relevant to the experiment's established theoretical relationship and initial boundaries. Reference data 22 may include, for example, known (compound) relationships, parameters and analytical data related to the initial experimental boundaries.

Experimental data 24 comprises information related and relevant to the relationships and boundaries determined through experimentation. Experimental data 24 may include, for example, actual analytical results obtained through experimentation within the initial experimental boundaries.

It is worth noting that experimental data 24 may be obtained from an instrumentation system 30, which may comprise laboratory equipment, such as a microscopy, spectroscopy, chromatography, assays and the like.

Preferably, a first iterative modeling and/or mining process is performed by the experiment evaluation and refinement system 20 to re-assess initial experimental boundaries in light of reference data 22 and experimental data 24. This re-assessment establishes a revised experimentation boundaries. In a preferred embodiment, this first iterative model is a statistical model. Effectively, the modeling and mining at this stage confirms patterns, identifies the existence of data relating to key attributes, and presents other viable options.

The enhancement techniques of the experiment evaluation and refinement system 20 and the resulting revised experimentation boundaries are provided with additional information, generated by a modeling system 40. The information provided by the modeling system 40 further optimizes the design of experiments.

The modeling system 40 may comprise, for example, modeling tools related to kinetics, computational fluid dynamics, process simulation, statistics, weighted statistics, Gaussian quantum mechanics and molecular mechanics, dynamics, and the like. The modeling system 40 may also comprise specific algorithmic approaches, such as those based on time, surface structure, Log P, solubility, molar refractivity, surface areas, molecular volumes, and the like.

Modeling tool(s) related to kinetics may be stochastic or integration based. The present invention is capable for connectivity with one or more existing modeling tools, including, but not limited to, “BatchCAD” available from GSE Systems, Inc., “DGauss” available from Oxford Molecular, “Chem3D Ultra 5.0” available from CambridgeSoft, “Gaussian98” available from Gaussian, Inc., “CAChe” or “WinMOPAC” available from Fujitsu, “SciLogP Ultra” available from SciVision, “Hyperchem” available from HyperCube, or “Chemical Kinetics Simulator” (CKS) available from IBM. As new modeling tools are developed, the present invention is capable of configuration for ready access thereto, thereby enhancing the strength of the modeling system 40.

The modeling system 40 further optimizes the design of experiments, in part, by generating simulated responses for chemical and/or biological reactions within the revised experimentation boundaries set by the experiment evaluation and refinement system 20. Additionally, the modeling system 40 provides further avenues to explore by, for example, determining pathways of synthesis with the highest likelihood of success, predicting experiment outcomes, and the like. Parameters for the modeling system include, but are not limited to, activation rate(s), absorption value(s), waste stream minimization factors, heat capacity, viscosity, heat transfer coefficient, vapor pressure, enthalpy, entropy, temperature, pressure, concentration profile, bulk properties, percent conversion, mass, energy, molecular structure, purity, protein sequence, protein structure and the like.

Noteworthy is the back-and-forth communication between the modeling system 40 and the experiment evaluation and refinement system 20, in that revised experimentation boundaries are re-assessed by the experiment evaluation and refinement system 20 in view of reference data 22, experimental data 24 as well as in view of responses provided by the modeling system 40. In a preferred embodiment, the result is the creation of one or more experimental choices and experiment certainty/preferences levels. In an alternate embodiment, the result is simulated outcomes of proposed experiments and the certainty levels of these outcomes.

The experimental choices and certainty levels of desired outcomes are converted to suggested formulas or experimental methods/protocols by a formulation system 50. The formulation system 50 provides suggested formulas or experimental methods, which can either be manually pursued or downloaded into a recipe management system 60.

The recipe management system preferably contains a recipe manager, which organizes and automates the recipe development process, preferably in alignment with S88 standards. The recipe manager contains a recipe builder that creates master recipes defined by terminologies specific to batch control systems. The recipe manager allows a user to perform functions, such as recipe management, scheduling, sequential control, regulatory control, safety interlocking systems, visualization of various stages of the development process, result analysis, tracking, activity log, and/or generation of custom reports relating to the experiment.

The recipe development process performed by the recipe management system 60 comprises the collection and organization of information, such as preferred chemicals, equipment specifications and constraints, safety considerations and constraints, environmental considerations and constraints, and time. This information is either entered by a user or retrieved from (physical property) databases. Preferably, the information is maintained in a data warehouse.

During operation of the recipe management system 60, each potential synthetic step of a chemical recipe is optimized, to yield a specific number of experiments. In a preferred embodiment, the experiments provided are variations of a base experiment. Aspects of the creation and analysis of experimental design may include, for example, measurement of the quantitative relationship between key factors and responses of interest, and the identification of those key factors having the largest impact on the responses of interest, such as yield, enantiomeric excess, and impurity level. These factors include, but are not limited to, temperature, pressure, equivalents, and/or solvent.

Construction of the synthetic recipe is preferably performed through a drag-and-drop process with the result being a recipe that is understood by process engineering modules. The chemical recipe is assembled from a broad assortment of operation objects, such as add solid, add liquid, heat, cool, extract, filter, and the like. Chemical structures may be imported or drawn in a chemical drawing package, such as ChemDraw or Intelligent Scheduling and Information System (ISIS). Guided methods are used to assign resources such as equipment and services to the recipe procedure. During construction of a chemical recipe, translation from a graphical user interface (GUI) may be achieved using standard batch control language to simplify necessary programming, configuration tasks, and communication between the various components of the system.

Additional or new data generated by conducting the experimental choices by the recipe management system 60 is captured either substantially instantaneously (i.e. on-line) or as a post reaction result via user input. In a preferred embodiment, the new data is stored in a relational database 62, such as an Oracle 9i, DB2, or a sybase database. Alternatively and optionally, the new data may be introduced to the experimental design system of the present invention as experimental data 24. This new data or additional information is incorporated and a revised output is generated to the visualization system 70, having a new set of proposed experiments and revised certainty levels.

In a preferred embodiment, data is captured and the experimental design is capable of substantially continuous modifications (i.e. on-line or “on the fly”). In this fashion, experiments may be truncated or modified in real time, thereby saving reagents and time while generating improved data.

The visualization system 70 facilitates visualization of response relationships and identifies those settings that result in an optimum response. Where desired, analysis results, significance, and statistical basis for conclusions may be incorporated into a customized report.

FIG. 2 shows a flow chart of the operation of the experimental design system of the present invention, in accordance with a preferred embodiment. As shown, the system includes a series of processing steps beginning with the establishment of one or more revised experimentation boundaries, as at Step 2 (S2). For example, the revised boundaries may relate to the kinetic parameters of a chemical entity. Each revised experimentation boundary value is inputted into a modeling tool (S4).

Based on the revised experimentation boundaries, the modeling tool estimates a concentration profile of the chemical entity under consideration (S6). An experiment evaluation and refinement tool then compares the concentration profile with previously input experimentally determined values of how each chemical compound comprising the chemical entity behaves (S8). The comparison results, which generally show both the values of the concentration of each chemical entity as well as the experimental values, are assessed/analyzed by experiment evaluation and refinement tool (S10), to determine whether the comparison of calculated values and experimentally determined values converge to a minima deemed to be satisfactory (Sl2).

If so, the value of the kinetic parameter at that instance is deemed to be a suitable value for the chemical entity under consideration (S14).

On the other hand, if the comparison yields a wide disparity in data values, the experiment evaluation and refinement tool attempts to improve upon the original prediction by providing another value to input into the modeling tool, as at Step 2 (S2). The process is repeated until a satisfactory global minimum is reached.

Although the system and method of the present invention has been described in detail for the purpose of illustration, it is understood that such detail is solely for that purpose, and variations can be made therein by those skilled in the art without departing from the spirit and scope of the invention. Thus, it will be appreciated that the foregoing description of the invention is by way of illustration only and not of limitation.

What is claimed is:

1. A system for designing experiments, the system comprising:
a communications device configured for accepting one or more data inputs establishing one or more experimental boundaries;
an experiment evaluation device configured for assessing one or more initial experimental boundaries and producing as an output, one or more experimental choices of desired outcomes, said experiment evaluation device in communication with said communications device;
one or more modeling devices for generating one or more simulated responses for each reaction of an entity under consideration within one or more revised experimentation boundaries;
a formulation device, in communication with said experiment evaluation device, configured for converting said output into one or more suggested experimental protocols; and
a management device, which receives said one or more suggested experimental protocols and organizes a development process of said entity into usable data.

2. The system as in claim 1, further comprising a visualization device for displaying one or more response relationships of said entity as desired.

3. The system as in claim 1, further comprising a visualization device for generating a report of one or more response relationships of said entity.

4. A computerized method of experimental design, said method comprising the steps of:
processing input data comprising one or more user defined variables that assist in establishing one or more initial experimental boundaries;
processing at least one of reference data and experimental data;
assessing said one or more initial experimental boundaries with reference to said reference data and said experimental data to form one or more revised experimental boundaries; and
simulating one or more scenarios within said one or more revised experimental boundaries to yield one or more experimental choices.

5. The method according to claim 4, wherein said one or more user defined variables include an importance of said input data.

6. The method according to claim 4, wherein said input data further comprises one or more user defined restraints that assist in establishing said one or more initial experimental boundaries.
